(19) United States
(12) Patent Application Publication
(10) Pub. No.: US 2006/0102264 A1
(43) Pub. Date: May 18, 2006

(54) Localised conductive rubber

(75) Inventor: Serge Nicolas, Clermont-Ferrand (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 11/281,357

(22) Filed: Nov. 18, 2005

(30) Foreign Application Priority Data
Nov. 18, 2004 (FR) 04/12281

(51) Int. Cl. B60C 19/08

(52) U.S. Cl. 152/152.1

(57) ABSTRACT

Tyre intended for mounting on a wheel and designed to support a load, consisting of a crown zone (S) with an outer surface intended to come in contact with the ground and comprising means to enable electricity to be conducted between the ground and a bead area (B) designed to ensure contact between the wheel and the tyre, whose constituent (5) in contact with the wheel is electrically conductive, and a sidewall zone (F) designed to connect the crown zone (S) to the bead area (B), characterised in that the constituents of the sidewall zone (F) are made from materials with very low electrical conductivity and the tyre comprises at least one conductive strip (8), of small thickness and width, made from an electrically conductive material and arranged radially along a path that extends from the interior part of the crown zone (S), with which it is in contact, to the bead area (B), where it is in contact with the said constituent (5) designed to be in contact with the wheel.

The invention concerns the field of tyres intended for fitting to transport vehicles. More particularly, it deals with the problem of the flow of electric charges in tyres made with rubber mixes that are very poor electrical conductors.

To improve their rolling resistance and reduce fuel consumption, modern tyres comprise mixes containing as their principal filler electrically non-conducting fillers such as silica, or even mixes with small amounts of carbon black.

The use of such mixes is widespread for the production of tyre treads, granted the advantages of such mixes in also improving performances related to grip on dry, wet or icy ground, resistance to wear, and even running noise. As an illustrative example, a tyre of this type is described in European Patent Application EP 0 501 227 B1.

However, the use of these mixes goes together with a difficulty related to the accumulation of static electricity as the vehicle is rolling, and the absence of any escape of these charges into the ground because of the very high resistivity of the mixes constituting the tread. When certain particular conditions exist, the static electricity accumulated in a tyre can give rise to a nasty electric shock to the occupant of a vehicle when he touches the body of the vehicle. This static electricity can also speed up the ageing of the tyre because of the ozone generated by electrical discharge. Depending on the nature of the ground and of the vehicle, it can also cause the on-board radio to malfunction because of the interferences it generates.

Accordingly, numerous solutions have been proposed for allowing the charges to flow away from the crown block into the ground.

U.S. Pat. No. 5 518 055 describes a tyre whose tread, produced from a mix with very low conductivity, is coated with a fine layer of conductive mix. This layer is in contact with the sidewall mixes, themselves electrically conductive, to allow the electric charges to flow away.

Another solution is disclosed in the application EP 0 658 452 A1, which describes the addition of a strip of mix or insert, made from a conductive rubber mix, which extends radially preferably over the full circumference of the tyre and which connects the outer surface of the tread either to one of the crown plies, or to the carcass reinforcement, or to any other part touching the tyre tread that is a sufficiently good conductor of electricity, the necessary conductivity being conferred by the presence of a suitable carbon black.

Numerous improvements have been made to this principle depending on whether the tread comprises one or more layers of materials that are conductive or very poorly conductive, as disclosed for example in the patents EP 0 925 903 B1 or EP 0 963 302 B1.

However, the aim of all these methods is to connect the outer surface of the tread with part of the internal zone of the tyre's crown just adjacent to it, such as the sidewall, a crown reinforcement ply or a carcass reinforcement ply, which has electrically conductive properties. The electric charges are then drained away into the ground from the wheel rim, which is connected to the vehicle, passing through the bead area in contact with the rim and then flowing along the sidewalls through the mixes constituting the carcass reinforcement ply or the sidewall protection rubbers towards an internal part of the crown zone, and finally flowing from the said internal part of the crown zone into the ground through the crown reinforcement and the tread.

However, recent tyre developments aiming to improve the rolling resistance have led to the use of mixes based on silica, or ones with very low carbon contents, in most compositions forming the tyre and able to perform mechanical work during the tyre's use. This can be the case with mixes used to make treads, sidewalls, carcass reinforcement plies or crown reinforcement plies, crown-reinforcing profiled elements and bead-reinforcing profiled elements, and the interior sealing rubber. Thus, all these materials are characterised by very low electrical conductivity.

Only elements of the tyre such as the bead reinforcement ring or bead protection rubbers whose fuiction is to ensure contact between the wheel rim and the lower part of the tyre, which are made of mixes containing a carbon-based filler, still have the property of conducting electricity.

The purpose of the invention is to provide a solution for the conduction of electric charges in tyres essentially made from mixes with very low electrical conductivity.

However, as will be seen later, the invention can concern both outer tyre casings that enclose a volume of air under pressure to support the load, and so-termed non-pneumatic tyres formed of one or more self-supporting elements such as those described as examples in the patent EP 1 056 604.

A material with very low electrical conductivity is understood to mean one whose resistivity is greater than or equal to 10⁸ Ohms/cm. Similarly, a material that conducts electricity is one whose resistivity is lower than 10⁶ Ohms/cm. These materials have the appropriate elastic properties and may or may not be of rubber-like nature.

Thus, in a general way the invention can be applied to a tyre intended for fitting on a wheel which itself conducts electricity, and designed to support a load, the said tyre consisting of:
a crown zone (S) having an outer surface intended to come into contact with the ground and comprising means to ensure the conduction of electricity between the ground and an internal part of the crown zone,
a bead area (B) designed to ensure contact between the wheel and the tyre, whose part (5) in contact with the wheel conducts electricity,
and a sidewall zone (F) designed to ensure connection between the crown zone (S) and the bead area (B).

This tyre is characterised in that:
the constituents of the sidewall zone (F) are made from materials with very low electrical conductivity,
the tyre comprises at least one conductive strip (8) of small thickness and width, made from an electrically conductive material and arranged along a path extending from the said internal part of the crown zone (S) with which it is in contact, to the bead area (B) where it is in contact with the said part (5) in contact with the wheel.

In what follows, the description will refer to the application of the invention to a tyre of the pneumatic type in which the crown zone (S) comprises a circumferential crown reinforcement consisting of at least one crown reinforcement ply, and a tread arranged circumferentially around the crown reinforcement, whose outer surface is in contact with the ground, the said crown zone being attached to a carcass reinforcement ply anchored at its two ends to the bead area (B), the said bead area comprising a bead protection rubber designed to ensure contact with the wheel and made from an electrically conductive material. Besides the carcass reinforcement ply, the sidewall zone can comprise a profiled element that protects the tyre against transverse impacts.

The mixes used to make the sidewall protection and the carcass reinforcement ply rubbers have very low electrical conductivity. Under these conditions there is no electrically conducting path between the crown zone S and the bead area B since, besides, the carcass reinforcement ply constitutes an insulator with the constituents located radially below it, such as the sealing rubber.

It does not matter whether the mixes used for making the tread or the crown reinforcement conduct electricity or have very low conductivity. In the latter case the tyre comprises means, known from the prior art, which enable electric charges to flow from the outer surface of the tread to its radially inner surface. The flow of charges from the inside portion of the crown zone to the ground can take place through the tread alone, or through the crown reinforcement and the tread.

The mixes used for making the bead protection rubbers are electrically conductive.

A conductive strip of small thickness and width, made from a material preferably of the nature of rubber and which conducts electricity, is arranged radially along a path extending from the said interior part of the crown zone S with which it is in contact, to the bead area B where it is in contact with the constituent in contact with the wheel.

Depending on whether or not the mixes used to make the crown reinforcement are electrically conductive, the end of the conductive strip in contact with the interior part of the crown zone is positioned above or below the crown reinforcement so as to allow charges to flow between the end of the strip and the ground passing either through the assembly formed by the crown reinforcement and the tread, or directly through the tread, the latter being able to be provided or not with an insert positioned radially between the surface of the tread and the said interior part, depending on the nature of the mix used to make the tread.

The advantages and nature of the invention will emerge more clearly on reading the description of an example of its implementation and referring to the figures, which show:

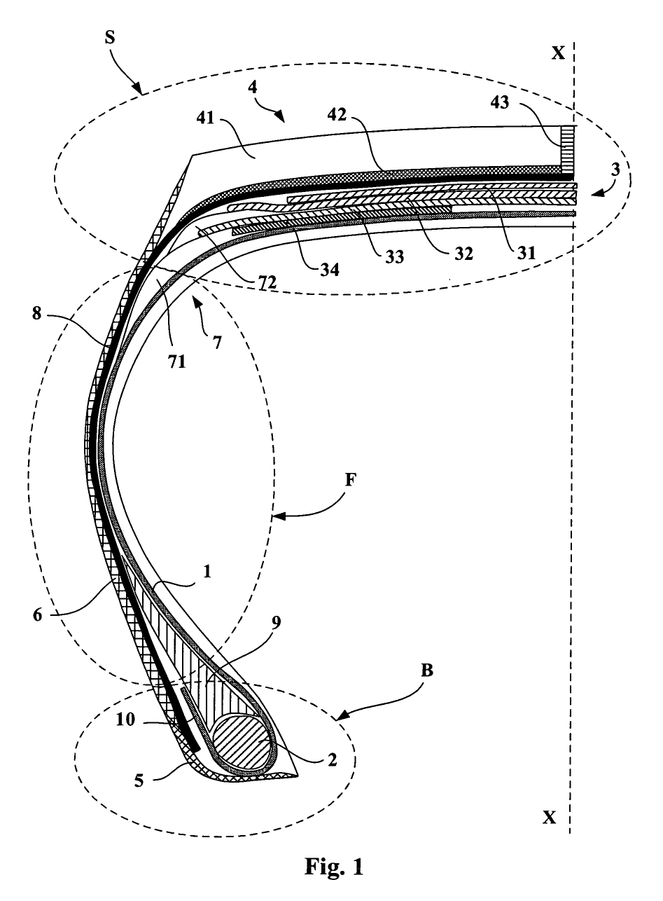

FIG. 1: Radial half-section of a tyre in which only the mixes used for the bead protection rubber and the insert are electrically conductive,

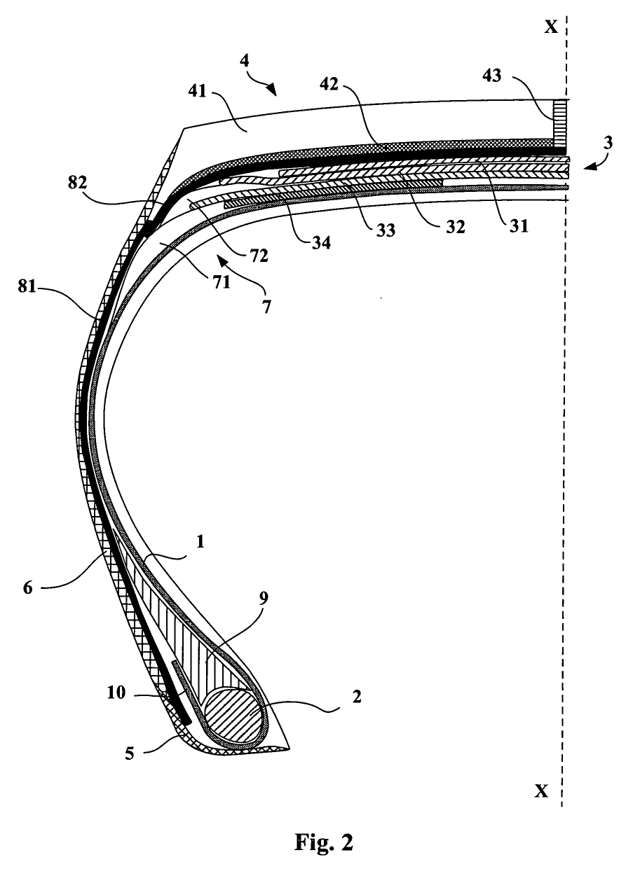

FIG. 2: Radial half-section of a tyre comparable to that of FIG. 1 and comprising a first variant embodiment of the conductive strip,

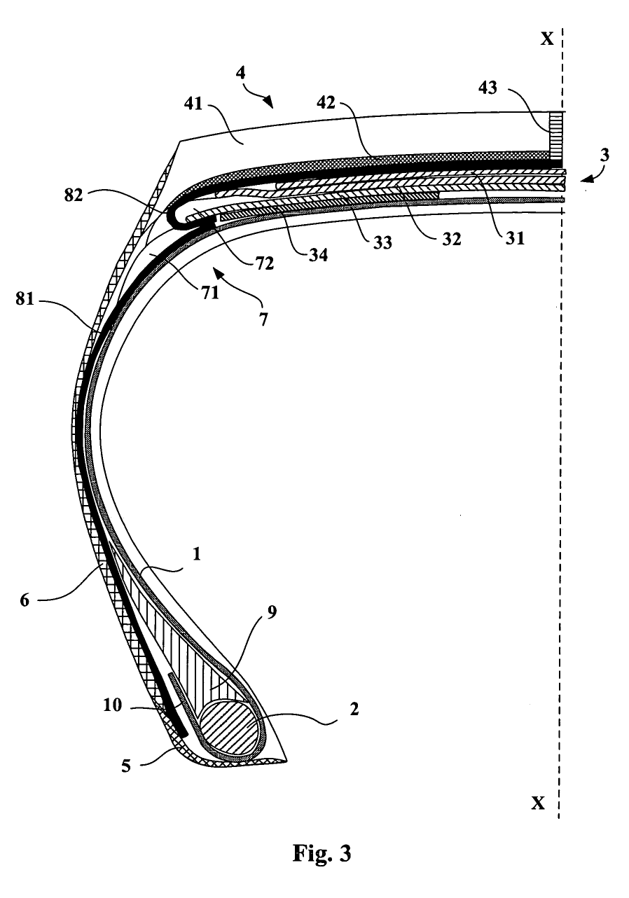

FIG. 3: Radial half-section of a tyre comparable to that of FIG. 1 and comprising a second variant embodiment of the conductive strip,

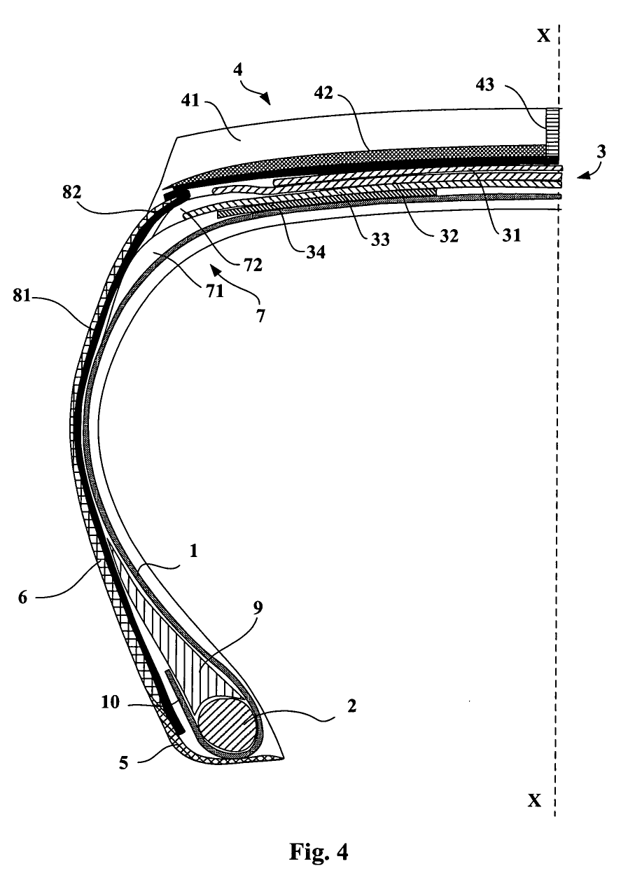

FIG. 4: Radial half-section of a tyre comparable to that of FIG. 1 and comprising a third variant embodiment of the conductive strip,

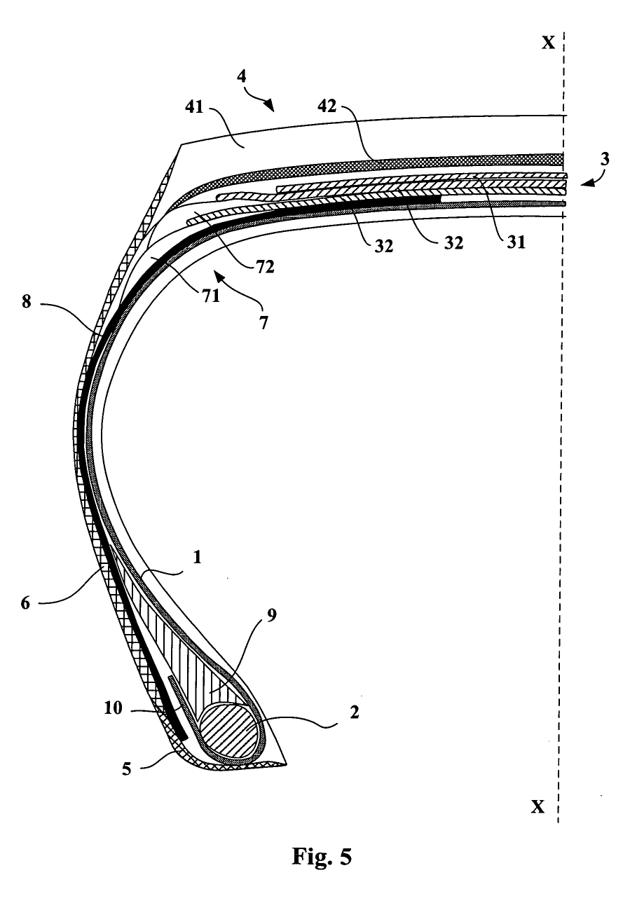

FIG. 5: Radial half-section of a tyre in which the crown reinforcement and the tread are made using electrically conductive mixes,

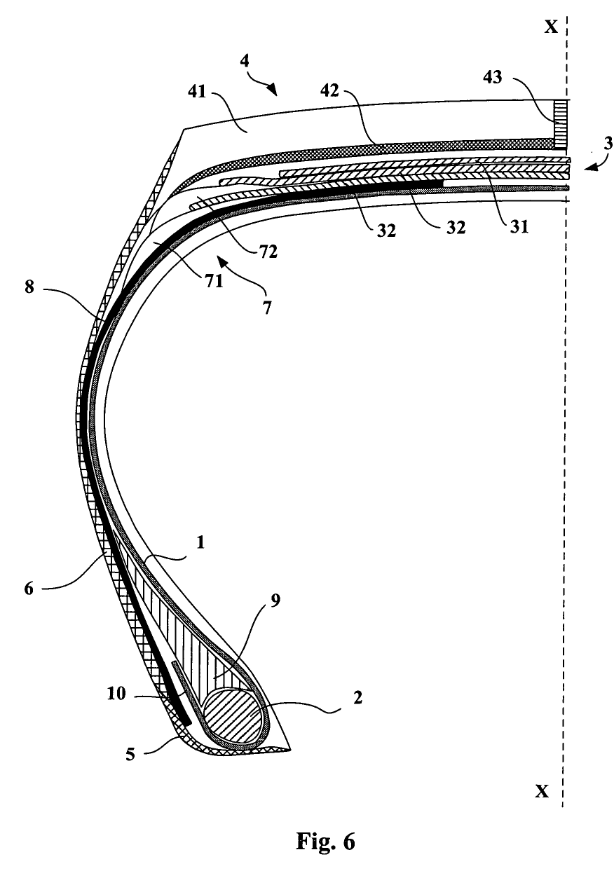

FIG. 6: Radial half-section of a tyre in which the crown reinforcement is made using electrically conductive mixes, and the tread is made using mixes with very low electrical conductivity,

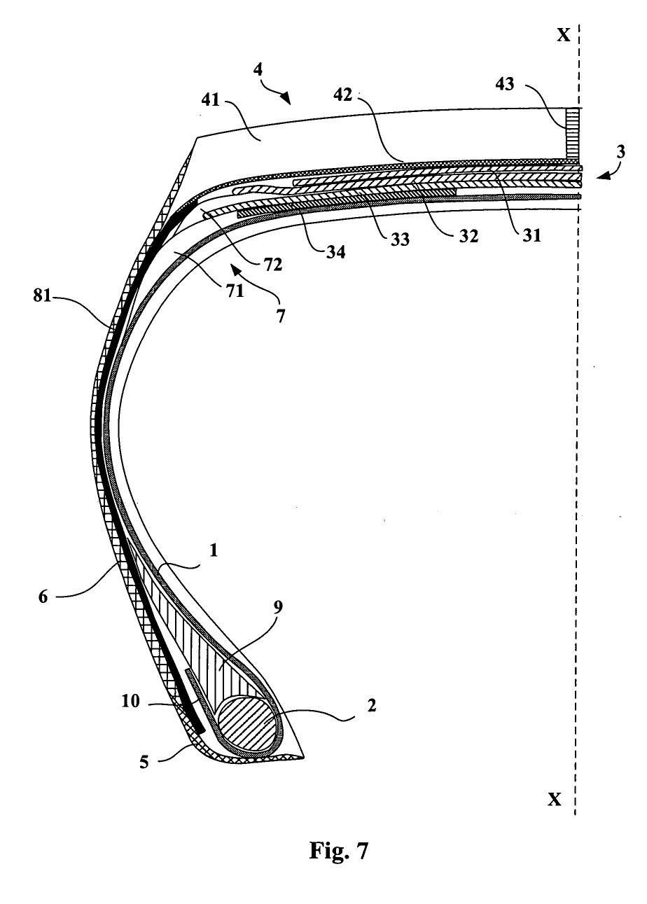

FIG. 7: Radial half-section of a tyre in which the tread and the crown reinforcement are made using mixes with very low electrical conductivity, and in which the underlying layer is made from an electrically conductive mix,

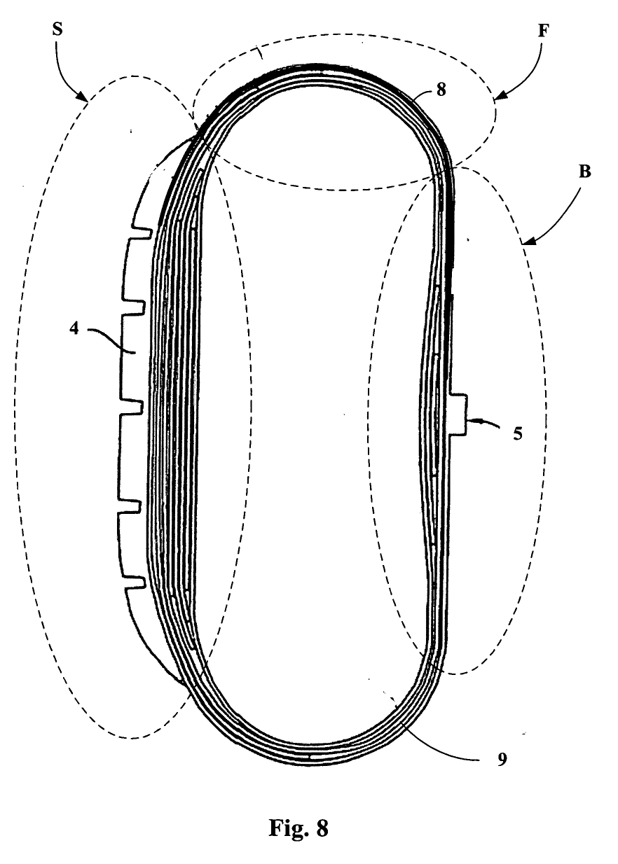

FIG. 8: Radial section of a non-pneumatic tyre made with self-supporting elements that do not conduct electricity.

The tyre shown in FIG. 1 comprises a carcass ply 1 anchored by turning up its two ends 10 around bead reinforcement rings 2. A rubber 6 protects the sidewalls. A crown reinforcement 3 consists of several circumferential crown reinforcement plies 31, 32, 33, 34 arranged radially one above the other. A tread 4 comprises a wear layer 41 and anunderlying layer 42. Since they are formed of materials with very low electrical conductivity, the tread and the underlying layer are traversed radially all round their circumference by an electrically conductive insert 43. Crown-reinforcing profiled elements 7 are arranged at the axial ends of the crown reinforcement plies in order to support (71) or to de-couple (72) the said ends of those plies. A profiled element 9 ensures the filling of the bead area. The bead protection rubber 5 establishes contact between the bead area and the wheel rim.

Dotted lines surround respectively the crown zone S, the bead area B and the sidewall zone F.

In this example, only the mixes need to make the bead protection rubber 5 and the insert 43 are electrically conductive. Thus, electric charges cannot flow freely between the crown zone S and the bead area B.

To ensure the conduction of electric charges between the crown zone and the bead area, the conductive strip 8 is arranged between the sidewall protection rubber and the carcass reinforcement in such manner that one of its ends is in contact with the bead protection rubber 5 and its other end is in contact with the part of the insert 43 which meets the radially inside surface of the tread and corresponds to the part of the tread located radially nearest to the rotation axis of the tyre.

The conductive strip 8, of small width and thickness, is made from an electrically conductive mix. The width of the strip can range from a few millimetres up to two or three centimetres, and is adapted to the manner to which the said strip is produced and used. This does not exclude the production of strips having smaller or larger widths. Likewise, and in a non-limiting way, the thickness can range from one or two tenths of a millimetre and one, or even two millimetres. Here too, the limits are imposed by the production process and the intended use.

The embodiment illustrated in FIG. 2 comprises a first conductive strip 81 arranged under the sidewall protection strip and with one of its ends in contact with the inside surface of the bead protection rubber 5. A second conductive strip 82 is arranged under the tread in such manner that one of its ends is in contact with the insert 43 ending at the radially inner surface of the tread 4, 41, 42. The two free ends of the conductive strips 81 and 82 are placed in contact with one another during the assembly of the crown onto the carcass after the said carcass has been shaped from a generally cylindrical shape to a toroidal shape.

The embodiment illustrated in FIG. 3 is made by laying a first conductive strip 81 on the carcass reinforcement ply and turning up the conductive strip 82, one of whose ends is in contact with the part of the insert 43 that meets the radially inner surface of the tread 4, around the crown reinforcement 3 so that the said end is in contact with the end of the conductive strip 81 previously laid on the carcass reinforcement ply 1.

When the end of the sidewalls 6 is positioned under the lateral wing of the tread 4, the conductive strip 81, one of whose ends is in contact with the bead reinforcement rubber 5, can be turned up around the radially outer end of the sidewall protection rubber so that the end of the strip 81 is in contact with the end of the conductive strip 82 positioned under the tread, whose other end is in contact with the part of the insert 43 that meets the radially inner surface of the tread, as illustrated in FIG. 4.

All these embodiments demand that the crown and the shaped carcass should be assembled with sufficient circumferential precision to enable the ends of the conductive strips 81 and 82 to be placed in contact.

When the mixes used to make the tread 4 and the crown reinforcement 3 are electrically conductive, it suffices for the end of the conductive strip to be in contact with the radially inner part of the crown reinforcement 3 as illustrated in FIG. 5. Charges then flow from the end of the conductive strip 8 in contact with the radially inner part of the crown reinforcement, directly through the crown reinforcement 3 and the tread 4.

An analogous configuration, illustrated in FIG. 6, is sufficient when the tread 4 consists of mixes with very low electrical conductivity but the said tread 4 comprises a circumferential inset 43 made from an electrically conductive mix, the said insert being arranged radially throughout the thickness of the said tread 4 and making contact with the radially outer part of the crown reinforcement 3. The electric charges then flow through the crown reinforcement 3 and the insert 43.

A last configuration illustrated in FIG. 7 shows the case of a tyre in which the tread 41 and the crown reinforcement 3 are made with mixes having very low electrical conductivity, while the underlying layer 42 is made from an electrically conductive mix. The tread then comprises an insert 43 to enable electric charges to flow between the ground and the underlying layer 42.

Under these conditions, to enable the flow of electric charges it suffices for the conductive strip 81 to be in contact at one end with the underlying layer 42 and at its other end with the inside surface of the bead protection rubber 5.

Implementation of this last solution is particularly advantageous in that there is no need to adopt special precautions when circumferentially orientating the crown block relative to the shaped carcass. Besides, the underlying layer 42 can consist of a simple connecting rubber only a few tenths of a millimetre thick, with all the conductivity properties desired.

It does not matter whether the conductive strip 8, 81, 82 is positioned on one side of the tyre, on the other side, or on both sides.

Likewise, it is entirely possible to create an electrically conductive path similar to those described earlier and equivalent to the positioning of a conductive strip, by spraying onto the desired path a rubber solution made from an electrically conductive mix. This thin solution layer has the same conductive properties as a conductive strip of small thickness, and can be put in place using for example a spray or brush.

The purpose of the embodiments described above is to illustrate particular ways of implementing the invention and the adaptations that are possible in the various most common ways of manufacturing tyres. Thus, without deviating from the concept of the invention, those engaged in the field will have no difficulty in finding adaptations appropriate for more particular implementations.

Thus, while remaining within the scope of the invention, a non-pneumatic tyre consisting of self-supporting elements with very low electrical conductivity as depicted in FIG. 6 can be rendered conductive by arranging a strip 8 made from a conductive material between the part of the crown S bearing the tread 4 and the bead area where means 5 are arranged for fixing the tyre onto the wheel, the said means being electrically conductive.

1-10. (canceled)

11. A tire mountable on a wheel to support a load, comprising:
a crown zone including a radially outer surface arranged for contacting the ground, and an interior portion disposed radially inwardly of the outer surface; a bead area configured to ensure contact between the tire and a wheel, the bead area including an electrically conductive portion arranged for contacting a wheel;
a sidewall zone connecting the crown zone and the bead area and formed of materials having low electrical conductivity, and
a thin narrow strip of electrically conductive material arranged along a generally radial path in contact with both said interior portion of the crown zone and said electrically conductive portion of said bead area.

12. A tire according to claim 11 wherein the crown zone comprises a circumferential crown reinforcement including at least one crown reinforcement ply and a thread arranged circumferentially around the circumferential crown reinforcement, the tread having the ground-contacting outer surface, the crown zone attached to a carcass reinforcement ply anchored at both of its ends to the bad area, the bead area comprising a bead protection rubber arranged to ensure contact with a wheel and comprising an electrically conductive material.

13. The tire according to claim 12, wherein the tread is electrically conductive, the crown reinforcement having low electrical conductivity, the conductive strip being in contact with a radially interior surface of the tread.

14. The tire according to claim 12, wherein the tread is electrically non-conductive and contains an insert formed of an electrically conductive mix, the insert extending generally radially throughout the thickness of the tread, the crown reinforcement formed of materials having low electrical conductivity, the strip being in contact with a portion of the strip that meets the radially interior surface of the tread.

15. The tire according to claim 13, wherein the conductive strip comprises a first strip and a second strip each having one end in contact with one another, the other end of the first strip being in contact with the inner surface of the bead protection rubber, and the other end of the second strip being in contact with the radially interior surface of the tread.

16. The tire according to claim 14, wherein the conductive strip comprises a first strip and a second strip each having one end in contact with one another, the other end of the first strip being in contact with the inner surface of the bead protection rubber and the other end of the second strip being in contact with a portion of the insert that meets the radially interior surface of the tread.

17. The tire according to claim 12, wherein the tread comprises means enabling electricity to be conducted from the outer surface to the inner surface, the elements constituting the crown reinforcement being electrically conductive and in contact with said means, the conductive strip being in contact with the radially inner part of the crown reinforcement.

18. The tire according to claim 12, wherein the tread does not conduct electricity and comprises means enabling electricity to be conducted from the outer surface to the inner surface, said tread comprising an underlying layer arranged on its inner face and comprising an electrically conductive mix, said underlying layer being in contact with said means, the elements constituting the crown reinforcement having very low electrical conductivity, the conductive strip being in contact at one end with the underlying layer.

19. The tire according to claim 11 wherein the conductive strip is formed from a rubber solution sprayed along a desired path.

20. The tire according to claim 11 comprising a circumferential tread supported by one or more flexible self-supporting elements having very low electrical conductivity and located on the inside of said tread, said supporting elements being connected to the wheel by means forming a non-pneumatic tire.
